(19) United States
(12) Patent Application Publication
(10) Pub. No.: US 2013/0170430 A1
(43) Pub. Date: Jul. 4, 2013

(54) METHOD AND APPARATUS FOR ACKNOWLEDGEMENT INCLUDING A GROUP IDENTIFIER

(71) Applicant: Maarten Menzo Wentink, Breukelen (NL)

(72) Inventor: Maarten Menzo Wentink, Breukelen (NL)

(73) Assignee: QUALCOMM Incorporated, San Diego, CA (US)

(21) Appl. No.: 13/338,755

(22) Filed: Dec. 28, 2011

(51) Int. Cl. H04W 4/00

(52) U.S. Cl. 370/328

(57) ABSTRACT

Systems, methods, and devices for performing acknowledgment signaling including a group identifier are described herein. In some aspects, a device receives an identifier identifying a plurality of wireless communication devices, such as a group identifier. The device then transmits an acknowledgment of whether data transmitted to the device was correctly received. The acknowledgment includes the identifier.

### BACKGROUND

1. Field

The present application relates generally to wireless communications, and more specifically to systems, methods, and devices for acknowledgement of received data including an identifier.

2. Background

In many telecommunication systems, communications networks are used to exchange messages among several interacting spatially-separated devices. Networks may be classified according to geographic scope, which could be, for example, a metropolitan area, a local area, or a personal area. Such networks would be designated respectively as a wide area network (WAN), metropolitan area network (MAN), local area network (LAN), wireless local area network (WLAN), or personal area network (PAN). Networks also differ according to the switching/routing technique used to interconnect the various network nodes and devices (e.g. circuit switching vs. packet switching), the type of physical media employed for transmission (e.g. wired vs. wireless), and the set of communication protocols used (e.g. Internet protocol suite, SONET (Synchronous Optical Networking), Ethernet, etc.).

Wireless networks are often preferred when the network elements are mobile and thus have dynamic connectivity needs, or if the network architecture is formed in an ad hoc, rather than fixed, topology. Wireless networks employ intangible physical media in an unguided propagation mode using electromagnetic waves in the radio, microwave, infra-red, optical, etc. frequency bands. Wireless networks advantageously facilitate user mobility and rapid field deployment when compared to fixed wired networks.

The devices in a wireless network may communicate information between each other. As part of communicating, it may be desirable for the transmitter of data to receive confirmation that the transmitted data has been received by the intended recipient. Thus, the receiver of the data may transmit an acknowledgment signal indicating whether or not the data was correctly received. If the acknowledgment signal indicates that the data was not correctly received, the transmitter may retransmit the data to the receiver. If the data is, again, not correctly received, the transmitter may initiate a process to improve the channel, such as estimating the channel, estimating optimal beamforming vectors, or changing the channel frequency.

When an acknowledgment signal is received, it is desirable for the receiver to know whether the acknowledgment signal is transmitted by the recipient of transmitted data or is transmitted by a device in another network.

### SUMMARY

The systems, methods, and devices of the invention each have several aspects, no single one of which is solely responsible for its desirable attributes. Without limiting the scope of this invention as expressed by the claims which follow, some features will now be discussed briefly. After considering this discussion, and particularly after reading the section entitled “Detailed Description” one will understand how the features of this invention provide advantages that include improved acknowledgment signaling including a group identifier.

One aspect of the disclosure provides a method of acknowledging received data. The method comprises receiving, at a wireless communication device, an identifier identifying a plurality of wireless communication devices. The method further comprises transmitting an acknowledgment of whether data transmitted to the wireless communication device was correctly received. The acknowledgment comprises the identifier.

Another aspect of the disclosure provides a method of receiving acknowledgment of transmitted data. The method comprises transmitting an identifier identifying a plurality of wireless communication devices and transmitting data to each of the plurality of wireless communication devices. The method further comprises receiving, from each of the plurality of wireless communication devices, an acknowledgment of the data transmitted to that wireless communication device. The acknowledgment comprises the identifier.

Another aspect of the disclosure provides an apparatus for acknowledging received data. The apparatus comprises a receiver configured to receive, at a wireless communication device, an identifier identifying a plurality of wireless communication devices. The apparatus further comprises a transmitter configured to transmit an acknowledgment of whether data transmitted to the wireless communication device was correctly received. The acknowledgment comprises the identifier.

Another aspect of the disclosure provides an apparatus for receiving acknowledgment of transmitted data. The apparatus comprises a transmitter configured to transmit an identifier identifying a plurality of wireless communication devices and to transmit data to each of the plurality of wireless communication devices. The apparatus further comprises a receiver configured to receive, from each of the plurality of wireless communication devices, an acknowledgment of the data transmitted to that wireless communication device. The acknowledgment comprises the identifier.

Another aspect of the disclosure provides an apparatus for acknowledging received data. The apparatus comprises means for receiving, at a wireless communication device, an identifier identifying a plurality of wireless communication devices. The apparatus further comprises means for transmitting an acknowledgment of whether data transmitted to the wireless communication device was correctly received. The acknowledgment comprises the identifier.

Another aspect of the disclosure provides an apparatus for receiving acknowledgment of transmitted data. The apparatus comprises means for transmitting an identifier identifying a plurality of wireless communication devices. The apparatus further comprises means for transmitting data to each of the plurality of wireless communication devices. The apparatus further comprises means for receiving, from each of the plurality of wireless communication devices, an acknowledgment of the data transmitted to that wireless communication device. The acknowledgment comprises the identifier.

Another aspect of the disclosure provides a computer readable medium comprising instructions. When executed, the instructions cause an apparatus to receive, at a wireless communication device, an identifier identifying a plurality of wireless communication devices. The instructions also cause an apparatus to transmit an acknowledgment of whether data transmitted to the wireless communication device was correctly received. The acknowledgment comprises the identifier.

Another aspect of the disclosure provides a computer readable medium comprising instructions. When executed, the instructions cause an apparatus to transmit an identifier identifying a plurality of wireless communication devices and to transmit data to each of the plurality of wireless communication devices. The instructions also cause an apparatus to receive, from each of the plurality of wireless communication devices, an acknowledgment of the data transmitted to that wireless communication device. The acknowledgment comprises the identifier.

### BRIEF DESCRIPTION OF THE DRAWINGS

FIG. 1 illustrates an example of a wireless communication system in which aspects of the present disclosure may be employed.

FIG. 2 illustrates various components that may be utilized in a wireless device that may be employed within the wireless communication system of FIG. 1.

FIG. 3 illustrates an example of the signaling that may occur for acknowledging receipt of data from a wireless device using a sequential acknowledgment scheme.

FIG. 4 illustrates an example of the signaling that may occur for acknowledging receipt of data from a wireless device using a sequential acknowledgment scheme when one of the stations does not detect transmitted data.

FIG. 5 illustrates another example of the signaling that may occur for acknowledging receipt of data from a wireless device using a sequential acknowledgment scheme when one of the stations does not detect transmitted data.

FIG. 6 illustrates another example of the signaling that may occur for acknowledging receipt of data from a wireless device including an identifier.

FIG. 7 illustrates an example of the signaling that may occur for acknowledging receipt of data from a wireless device using a block acknowledgment scheme including an identifier.

FIG. 8 illustrates an aspect of a method for transmitting an acknowledgment of data in a wireless network.

FIG. 9 illustrates an aspect of a method for receiving acknowledgments from multiple wireless devices in a wireless network.

FIG. 10 is a functional block diagram of another exemplary wireless device that may be employed within the wireless communication system of FIG. 1.

FIG. 11 is a functional block diagram of another exemplary wireless device that may be employed within the wireless communication system of FIG. 1.

### DETAILED DESCRIPTION

Various aspects of the novel systems, apparatuses, and methods are described more fully hereinafter with reference to the accompanying drawings. The teachings disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein one skilled in the art should appreciate that the scope of the disclosure is intended to cover any aspect of the novel systems, apparatuses, and methods disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect disclosed herein may be embodied by one or more elements of a claim.

Although particular aspects are described herein, many variations and permutations of these aspects fall within the scope of the disclosure. Although some benefits and advantages of the preferred aspects are mentioned, the scope of the disclosure is not intended to be limited to particular benefits, uses, or objectives. Rather, aspects of the disclosure are intended to be broadly applicable to different wireless technologies, system configurations, networks, and transmission protocols, some of which are illustrated by way of example in the figures and in the following description of the preferred aspects. The detailed description and drawings are merely illustrative of the disclosure rather than limiting, the scope of the disclosure being defined by the appended claims and equivalents thereof.

Popular wireless network technologies may include various types of wireless local area networks (WLANs). A WLAN may be used to interconnect nearby devices together, employing widely used networking protocols. The various aspects described herein may apply to any communication standard, such as WiFi or, more generally, any member of the IEEE 802.11 family of wireless protocols. For example, the various aspects described herein may be used as part of the IEEE 802.11ah protocol, which uses sub-1 GHz bands.

In some aspects, wireless signals in a sub-gigahertz band may be transmitted according to the 802.11ah protocol using orthogonal frequency-division multiplexing (OFDM), direct-sequence spread spectrum (DSSS) communications, a combination of OFDM and DSSS communications, or other schemes. Implementations of the 802.11ah protocol may be used for sensors, metering, and smart grid networks. Advantageously, aspects of certain devices implementing the 802.11ah protocol may consume less power than devices implementing other wireless protocols, and/or may be used to transmit wireless signals across a relatively long range, for example about one kilometer or longer.

In some implementations, a WLAN includes various devices which are the components that access the wireless network. For example, there may be two types of devices: access points (“APs”) and clients (also referred to as stations, or “STAs”). In general, an AP serves as a hub or base station for the WLAN and an STA serves as a user of the WLAN. For example, an STA may be a laptop computer, a personal digital assistant (PDA), a mobile phone, etc. In an example, an STA connects to an AP via a WiFi (e.g., IEEE 802.11 protocol such as 802.11ah) compliant wireless link to obtain general connectivity to the Internet or to other wide area networks. In some implementations an STA may also be used as an AP.

An access point (“AP”) may also comprise, be implemented as, or known as a NodeB, Radio Network Controller (“RNC”), eNodeB, Base Station Controller (“BSC”), Base Transceiver Station (“BTS”), Base Station (“BS”), Transceiver Function (“TF”), Radio Router, Radio Transceiver, or some other terminology.

A station “STA” may also comprise, be implemented as, or known as an access terminal (“AT”), a subscriber station, a subscriber unit, a mobile station, a remote station, a remote terminal, a user terminal, a user agent, a user device, user equipment, or some other terminology. In some implementations an access terminal may comprise a cellular telephone, a cordless telephone, a Session Initiation Protocol (“SIP”) phone, a wireless local loop (“WLL”) station, a personal digital assistant (“PDA”), a handheld device having wireless connection capability, or some other suitable processing device connected to a wireless modem. Accordingly, one or more aspects taught herein may be incorporated into a phone (e.g., a cellular phone or smartphone), a computer (e.g., a laptop), a portable communication device, a headset, a portable computing device (e.g., a personal data assistant), an entertainment device (e.g., a music or video device, or a satellite radio), a gaming device or system, a global positioning system device, or any other suitable device that is configured to communicate via a wireless medium.

As discussed above, certain of the devices described herein may implement the 802.11ah standard, for example. Such devices, whether used as an STA or AP or other device, may be used for smart metering or in a smart grid network. Such devices may provide sensor applications or be used in home automation. The devices may instead or in addition be used in a healthcare context, for example for personal healthcare. They may also be used for surveillance, to enable extended-range Internet connectivity (e.g. for use with hotspots), or to implement machine-to-machine communications.

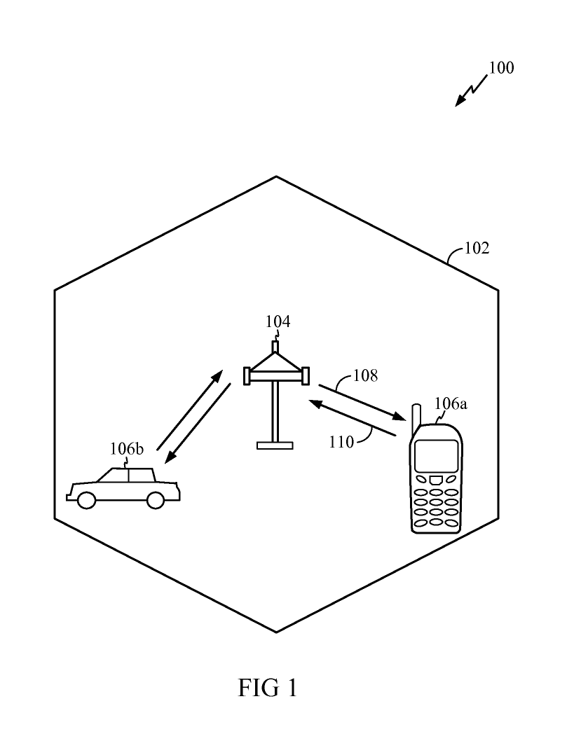

FIG. 1 illustrates an example of a wireless communication system 100 in which aspects of the present disclosure may be employed. The wireless communication system 100 may operate pursuant to a wireless standard, for example the 802.11ah standard. The wireless communication system 100 may include an AP 104, which communicates with STAs 106.

A variety of processes and methods may be used for transmissions in the wireless communication system 100 between the AP 104 and the STAs 106. For example, signals may be sent and received between the AP 104 and the STAs 106 in accordance with OFDM/OFDMA techniques. If this is the case, the wireless communication system 100 may be referred to as an OFDM/OFDMA system. Alternatively, signals may be sent and received between the AP 104 and the STAs 106 in accordance with CDMA techniques. If this is the case, the wireless communication system 100 may be referred to as a CDMA system.

A communication link that facilitates transmission from the AP 104 to one or more of the STAs 106 may be referred to as a downlink (DL) 108, and a communication link that facilitates transmission from one or more of the STAs 106 to the AP 104 may be referred to as an uplink (UL) 110. Alternatively, a downlink 108 may be referred to as a forward link or a forward channel, and an uplink 110 may be referred to as a reverse link or a reverse channel.

The AP 104 may act as a base station and provide wireless communication coverage in a basic service area (BSA) 102. The AP 104 along with the STAs 106 associated with the AP 104 and that use the AP 104 for communication may be referred to as a basic service set (BSS). It should be noted that the wireless communication system 100 may not have a central AP 104, but rather may function as a peer-to-peer network between the STAs 106. Accordingly, the functions of the AP 104 described herein may alternatively be performed by one or more of the STAs 106. Further, the functions of the STAs 106 described herein may alternatively be performed by one or more of the APs 104.

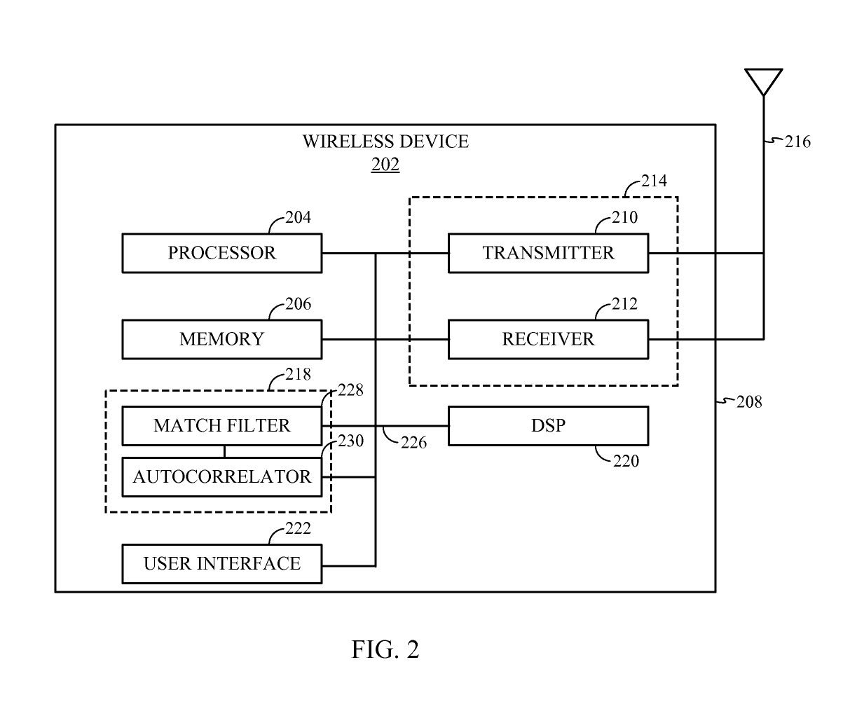

FIG. 2 illustrates various components that may be utilized in a wireless device 202 that may be employed within the wireless communication system 100. The wireless device 202 is an example of a device that may be configured to implement the various methods described herein. For example, the wireless device 202 may comprise the AP 104 or one of the STAs 106.

The wireless device 202 may include a processor 204 which controls operation of the wireless device 202. The processor 204 may also be referred to as a central processing unit (CPU). Memory 206, which may include both read-only memory (ROM) and random access memory (RAM), provides instructions and data to the processor 204. A portion of the memory 206 may also include non-volatile random access memory (NVRAM). The processor 204 typically performs logical and arithmetic operations based on program instructions stored within the memory 206. The instructions in the memory 206 may be executable to implement the methods described herein.

When the wireless device 202 is implemented or used as a transmitting node, the processor 204 may be configured to generate data, process data, and control operation of the wireless device 202, as discussed in further detail below.

When the wireless device 202 is implemented or used as a receiving node, the processor 204 may be configured to generate data, process data, and control operation of the wireless device 202, as discussed in further detail below.

The processor 204 may comprise or be a component of a processing system implemented with one or more processors. The one or more processors may be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations or other manipulations of information.

The processing system may also include machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein.

The wireless device 202 may also include a housing 208 that may include a transmitter 210 and/or a receiver 212 to allow transmission and reception of data between the wireless device 202 and a remote location. The transmitter 210 and receiver 212 may be combined into a transceiver 214. An antenna 216 may be attached to the housing 208 and electrically coupled to the transceiver 214. The wireless device 202 may also include (not shown) multiple transmitters, multiple receivers, multiple transceivers, and/or multiple antennas. The transmitter 210 may be configured to wirelessly transmit data. The receiver 212 may be configured to receive data.

The wireless device 202 may also include a signal detector 218 that may be used in an effort to detect and quantify the level of signals received by the transceiver 214. The signal detector 218 may detect such signals as total energy, energy per subcarrier per symbol, power spectral density and other signals. The wireless device 202 may also include a digital signal processor (DSP) 220 for use in processing signals. The DSP 220 may be configured to generate a packet for transmission. In some aspects, the packet may comprise a physical layer data unit (PPDU).

The wireless device 202 may further comprise a user interface 222 in some aspects. The user interface 222 may comprise a keypad, a microphone, a speaker, and/or a display. The user interface 222 may include any element or component that conveys information to a user of the wireless device 202 and/or receives input from the user.

The various components of the wireless device 202 may be coupled together by a bus system 226. The bus system 226 may include a data bus, for example, as well as a power bus, a control signal bus, and a status signal bus in addition to the data bus. Those of skill in the art will appreciate the components of the wireless device 202 may be coupled together or accept or provide inputs to each other using some other mechanism.

Although a number of separate components are illustrated in FIG. 2, those of skill in the art will recognize that one or more of the components may be combined or commonly implemented. For example, the processor 204 may be used to implement not only the functionality described above with respect to the processor 204, but also to implement the functionality described above with respect to the signal detector 218 and/or the DSP 220. Further, each of the components illustrated in FIG. 2 may be implemented using a plurality of separate elements.

For ease of reference, when the wireless device 202 is configured as a transmitting node, it is hereinafter referred to as a wireless device 202t. Similarly, when the wireless device 202 is configured as a receiving node, it is hereinafter referred to as a wireless device 202r. A device in the wireless communication system 100 may implement only functionality of a transmitting node, only functionality of a receiving node, or functionality of both a transmitting node and a receive node.

As discussed above, the wireless device 202 may comprise an AP 104 or an STA 106, and may be used to transmit and/or receive data.

Described herein are systems and methods for transmitting and receiving an acknowledgment signal including an identifier, such as a group identifier.

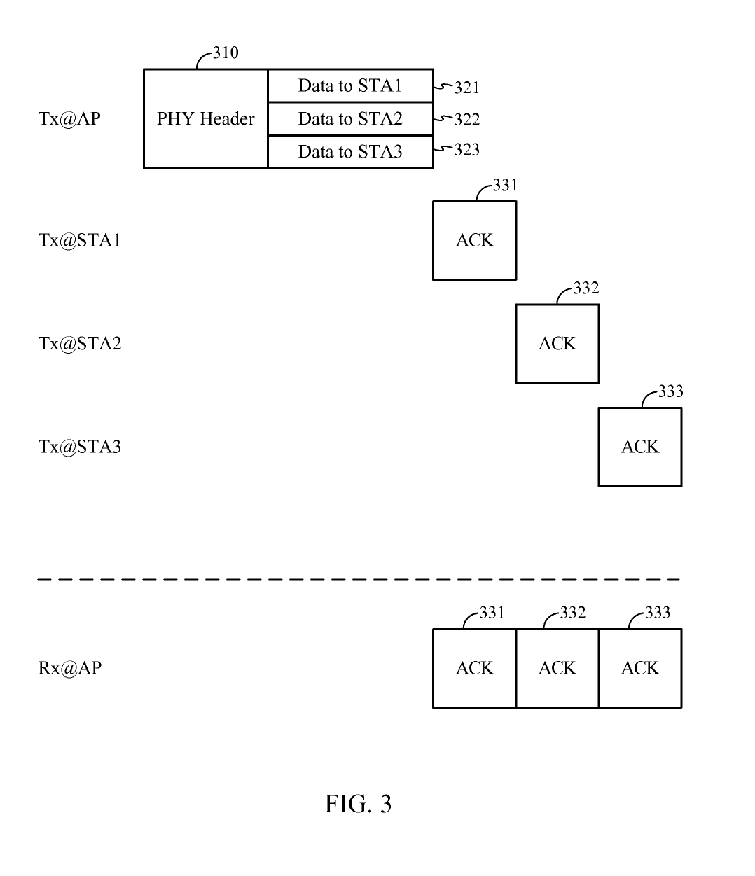

FIG. 3 illustrates an example of the signaling that may occur for acknowledging receipt of data from a wireless device using a sequential acknowledgment scheme. The signaling begins with the transmission by the access point (AP) of a PHY header 310. The PHY header 310 may be a broadcast transmission at the beginning of a transmission frame. The broadcast transmission may be received by all the stations associated with the AP as well as by stations not associated with the AP. The PHY header 310 may be transmitted at a data rate which is capable of being received by all of the stations associated with the AP. This data rate may be lower than that of at least some of the subsequently transmitted data 321, 323, and 324. The PHY header 310 may be transmitted using a data modulation which is capable of being received by all of the stations associated with the AP, e.g., BPSK. This modulation may be simpler than that of at least some of the subsequently transmitted data 321, 322, and 323, e.g., QPSK, 16-QAM, etc. The PHY header 310 may include information regarding the AP or the network of which the AP is a part. The PHY header 310 may include information regarding subsequently transmitted data 321, 322, and 323, such as the length of a data transmission period.

The PHY header 310 is followed by transmission by the AP of data to a first station (STA1) 321, data to a second station (STA2) 322, and data to a third station (STA3) 323. The transmitted data may be transmitted simultaneously or concurrently, at least in part. To achieve this, the data transmissions 321, 322, and 323 may be beamformed or otherwise spatially directed to their respective stations. In another embodiment, the data transmissions 321, 322, and 323 are transmitted at different frequencies or at different times.

Once data has been transmitted, it is beneficial for the AP to know whether the data has been detected and properly decoded. Data may be considered correctly received if a cyclic redundancy check (CRC) or other parity bit or sequence indicates correct reception. If the data has not been correctly received and this information is conveyed to the AP, the AP may retransmit the data in a later transmission.

Thus, the signaling continues with a sequential acknowledgment (ACK) sequence in which each station transmits an ACK signal back to the AP. The ACK signal indicates whether or not the station has detected and properly decoded transmitted data. The ACK signal may be a single bit which indicates whether or not the data was correctly received. Alternatively, as described in detail below, the ACK signal may be a Block ACK with many bits which indicate whether respective subsections of the transmitted data were correctly received.

The sequential ACK sequence includes an ACK signal from each of the stations, including an ACK signal from STA1 331, an ACK signal from STA2 332, and an ACK signal from STA3 333. Each station transmits its respective ACK signal at a predetermined order or time such that ACK signals are not transmitted simultaneously. The predetermined order or time may be assigned by the AP or determined by each station based on an order. The order may be, e.g., the order in which the stations associated with the AP. Thus, based on this understanding but without coordination between the stations, the ACK from STA1 331 is immediately followed by ACK from STA2 332 which is immediately followed by the ACK from STA3 333. From the perspective of AP, the AP receives three consecutive ACK signals and is able to determine, based on the order and the respective times at which the ACK signals are received, which ACK signal corresponds to which station. If all transmitted data is correctly received, the ACK signals would indicate that STA1 correctly received data, STA2 correctly received data, and STA3 correctly received data. Thus, no retransmission by the AP would be necessary.

In some embodiments, a station which receives no data does not transmit an ACK signal. Data may not be received by a station because (1) no data was transmitted to the station or (2) data was transmitted to the station but not detected. In the first case, transmission of an ACK signal by the station informs the AP that no data was received. However, this fact is known to the AP as the AP knows that no data has been sent. Thus, transmission of an ACK signal wastes power and bandwidth. In the second case, transmission of an ACK signal usefully informs the AP that the transmitted data was not correctly received. However, the AP can assume that the data was not correctly received when no ACK is received in response. Still, an ACK signal may inform the AP that detected data was properly decoded or not properly decoded.

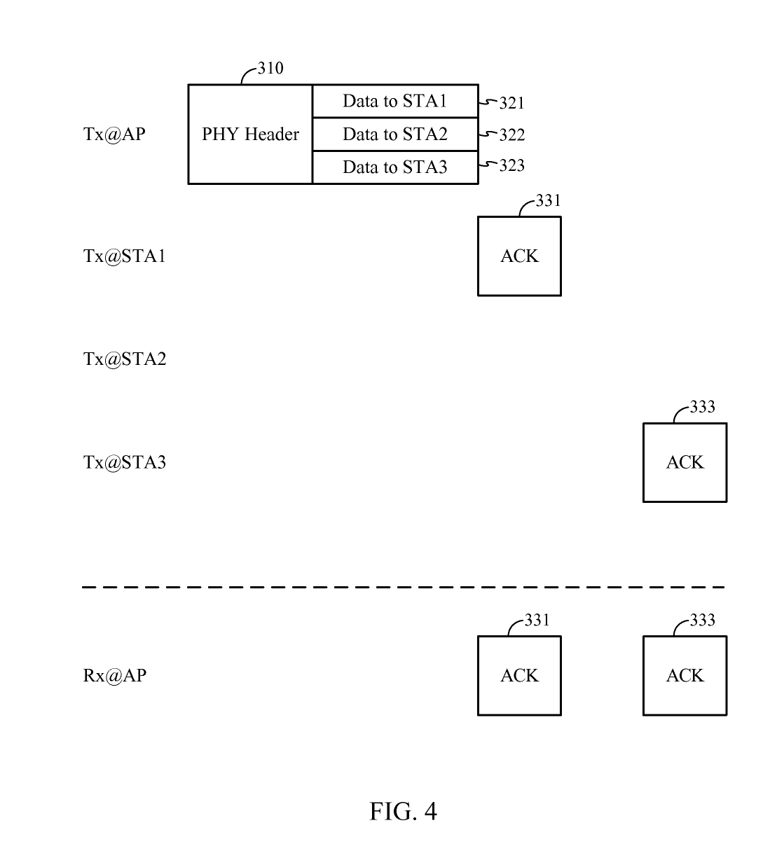

FIG. 4 illustrates an example of the signaling that may occur for acknowledging receipt of data from a wireless device using a sequential acknowledgment scheme when one of the stations does not detect transmitted data. The signaling of FIG. 4 begins, as in FIG. 3, with the broadcast transmission by the access point (AP) of a PHY header 310. The PHY header 310 is followed by transmission by the AP of data to STA1 321, data to STA2 322, and data to STA3 323.

The signaling continues with a sequential acknowledgment (ACK) sequence in which each station which detects that data has been transmitted to it transmits an ACK signal back to the AP. The ACK signal indicates whether or not the station has properly decoded the transmitted data. The ACK signal may be a single bit which indicates whether or not the data was properly decoded. Alternatively, the ACK signal may be a Block ACK with many bits which indicate whether respective subsections of the transmitted data were correctly received.

In the example illustrated in FIG. 4, the sequential ACK sequence includes an ACK signal from STA1 331 and an ACK signal from STA3 333, but does not include an ACK signal from STA2. In the example illustrated in FIG. 4, STA2 has not detected the transmitted data. Thus, the AP receives an ACK signal at a time allocated for the ACK signal from STA1 331, nothing during a time allocated for the ACK signal from STA2 332, and an ACK signal at a time allocated for the ACK signal from STA3 333. Thus, the AP can assume either (1) that STA2 did not detect the transmitted data (a problem with the downlink channel) or (2) that the AP did not receive the ACK from STA2 (a problem with the uplink channel). In response to not receiving an ACK signal from STA2, the AP may retransmit the same data to STA2 322 in a later transmission.

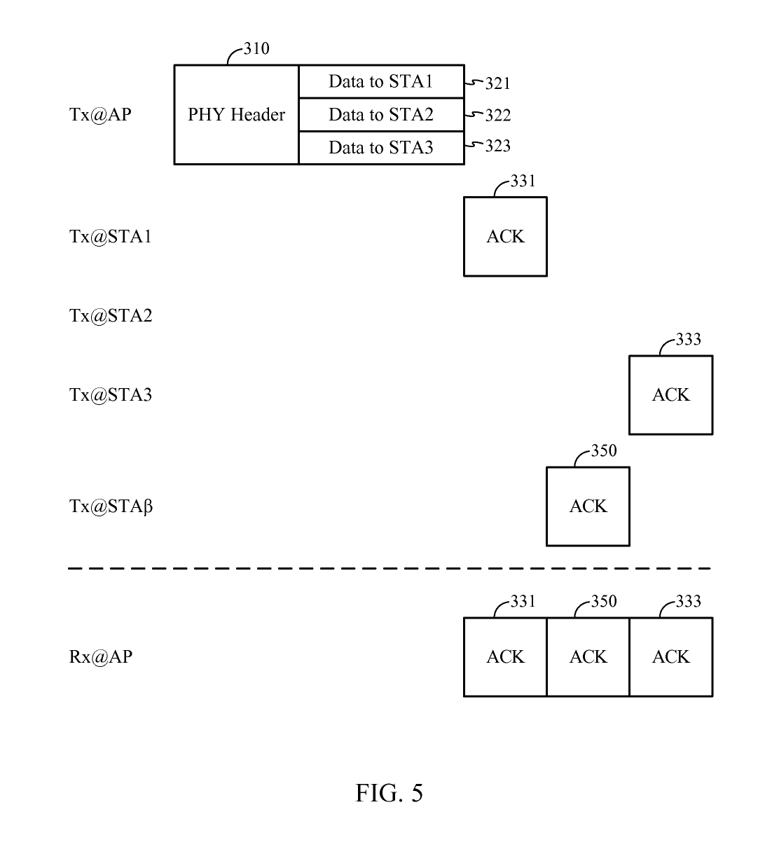

FIG. 5 illustrates another example of the signaling that may occur for acknowledging receipt of data from a wireless device using a sequential acknowledgment scheme when one of the stations does not detect transmitted data. The signaling of FIG. 5 begins, as in FIG. 4, with the broadcast transmission by the access point (AP) of a PHY header 310. The PHY header 310 is followed by transmission by the AP of data to STA1 321, data to STA2 322, and data to STA3 323.

The signaling continues with a sequential acknowledgment (ACK) sequence in which each station which detects that data has been transmitted to it transmits an ACK signal back to the AP. The ACK signal indicates whether or not the station has properly decoded the transmitted data. The ACK signal may be a single bit which indicates whether or not the data was properly decoded. Alternatively, the ACK signal may be a Block ACK with many bits which indicate whether respective subsections of the transmitted data were correctly received.

In the example illustrated in FIG. 5, the sequential ACK sequence includes an ACK signal from STA1 331 and an ACK signal from STA3 333, but does not include an ACK signal from STA2. In the example illustrated in FIG. 5, as in the example illustrated in FIG. 4, STA2 has not detected the transmitted data. The ACK sequence also includes an ACK signal from a station (STAβ) in another network not associated with the AP. The ACK signal from STAβ 350 may indicate to a device of a different network that data transmitted to STAβ from the device of the different network has been properly received.

Thus, the AP receives an ACK signal at a time allocated for the ACK signal from STA1 331 and an ACK signal at a time allocated for the ACK signal from STA3 333. Unlike the example of FIG. 4, the AP also receives an ACK signal at the time allocated for the ACK from STA2. However, the received ACK signal is not from STA2, but rather from STAβ. Having received it at the time allocated for the ACK signal from STA2, the AP assumes it is from STA2, assumes that STA2 correctly received the transmitted data, and does not retransmit the data to STA2 in a later transmission. Thus, STA2 never receives the data.

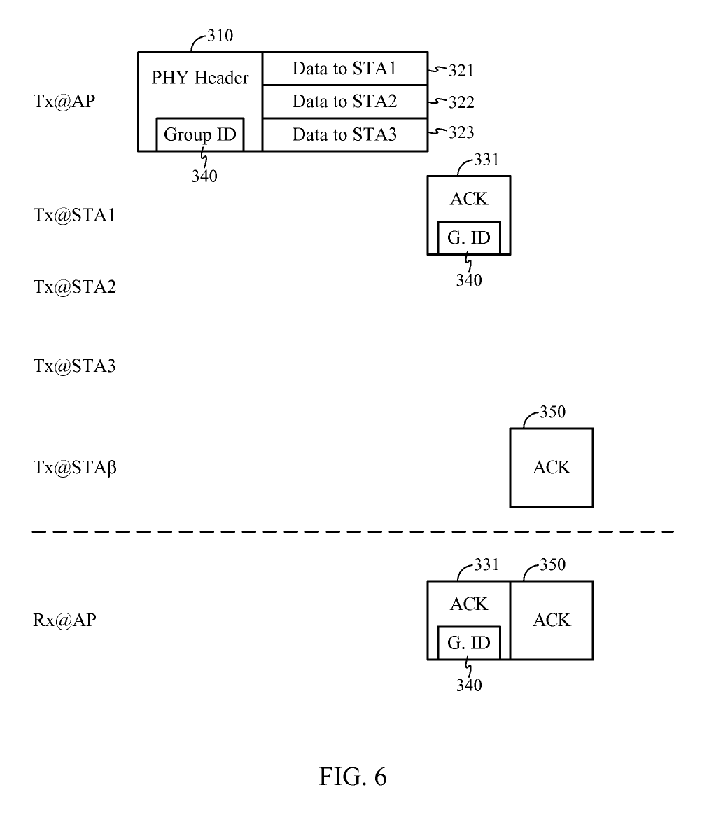

FIG. 6 illustrates another example of the signaling that may occur for acknowledging receipt of data from a wireless device including an identifier. The signaling of FIG. 6 begins, as in FIG. 5, with the broadcast transmission by the access point (AP) of a PHY header 310. The PHY header 310 includes an identifier 340. The identifier 340 may include a network identifier. The identifier 340 may include a device identifier, such as a MAC address, identifying the AP. In one embodiment, the identifier 340 is a group identifier (Group ID) that identifies a subset of the stations associated with the AP. The group identifier may, for example, identify the subset of stations which are being transmitted data in a particular frame. The PHY header 310 is followed by transmission by the AP of data to STA1 321, data to STA2 322, and data to STA3 323.

The signaling continues with a sequential acknowledgment (ACK) sequence in which each station which detects that it has received data transmits an ACK signal back to the AP. In the example illustrated in FIG. 6, the sequential ACK sequence includes an ACK signal from STA1 331, but does not include an ACK signal from STA2 or STA3. The ACK signal from STA1 includes the identifier 340. In the example illustrated in FIG. 6, as in the example illustrated in FIG. 5, STA2 has not detected the transmitted data. Further, as in the example illustrated in FIG. 5, the ACK sequence includes an ACK signal from STAβ 350, a station in another network not associated with the AP. The ACK signal from STAβ 350 may indicate to device of a different network that data transmitted to STAβ from the device of the different network has been properly received. The ACK signal from STAβ 350 may not include the identifier. In some cases, the ACK signal from STAβ 350 may include a different identifier which identifies a different network or a different device. The STA3 detects the ACK signal from STAβ 350 and determines that the ACK signal from STAβ 350 does not include the identifier 340. Accordingly, the STA3 terminates the ACK procedure and does not transmit an ACK.

Thus, the AP receives an ACK signal at an order or time allocated for the ACK signal from STA1 331. Like the example of FIG. 5, the AP also receives an ACK signal at the order or time allocated for the ACK from STA2. However, as in the example of FIG. 5, the received ACK signal is not from STA2, but rather from STAβ. Even though the AP receives the ACK signal from STAβ 350 at the time allocated for receipt of an ACK signal from STA2, the AP knows that the ACK signal is not from STA2 because it does not include the identifier 340. Accordingly, the AP may retransmit the data to STA2 in a later transmission.

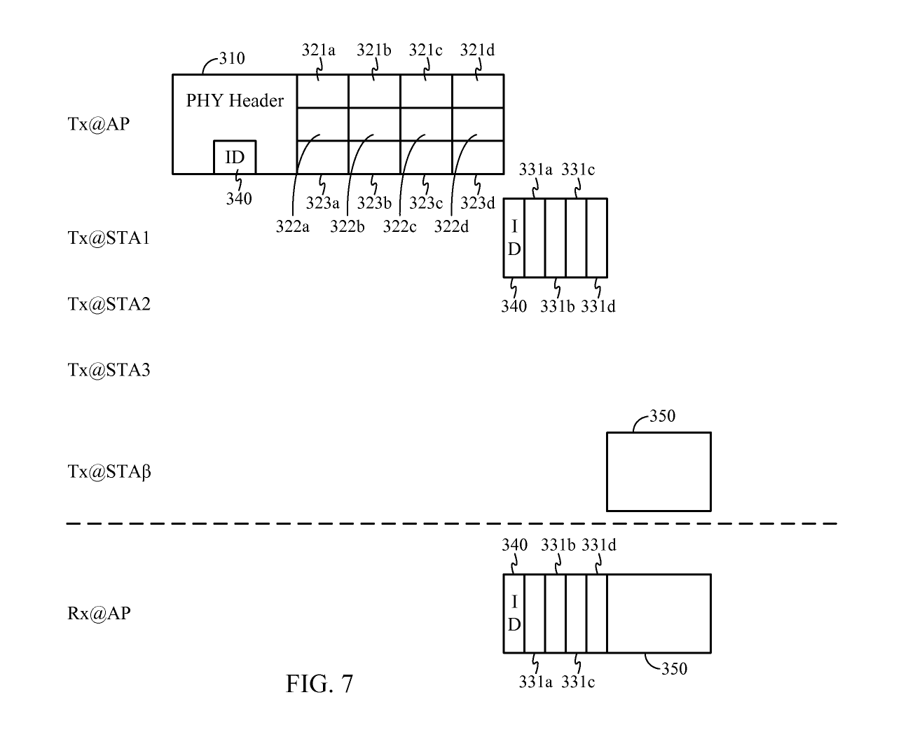

FIG. 7 illustrates an example of the signaling that may occur for acknowledging receipt of data from a wireless device using a block acknowledgment scheme including an identifier. The signaling of FIG. 7 begins, as in FIG. 6, with the broadcast transmission by the access point (AP) of a PHY header 310. The PHY header 310 includes an identifier 340. The identifier 340 may include a network identifier. The identifier 340 may include a device identifier, such as a MAC address, identifying the AP. In one embodiment, the identifier 340 is a group identifier (Group ID) that identifies a subset of the stations associated with the AP. The group identifier may, for example, identify the subset of stations which are being transmitted data in a particular frame. The PHY header 310 is followed by transmission by the AP of data to STA1 321, data to STA2 322, and data to STA3 323. Each data transmission 321, 322, and 323 is partitioned into a plurality of data transmission subunits 321a-d, 322a-d, and 323a-d.

The signaling continues with a sequential acknowledgment (ACK) sequence in which each station which detects that it has received data transmits an ACK signal back to the AP. In the example illustrated in FIG. 7, the sequential ACK sequence includes a block ACK signal from STA1 331, but no ACK signal from STA2 or STA3. The block ACK signal from STA1 includes a plurality of ACK signal subunits 331a-d. Each ACK signal subunit indicates whether or not the station has detected and properly decoded the respective data subunit.

As described above, when the AP receives a negative ACK, an indication that data was not properly decoded, the AP may retransmit the data in a later transmission. By partitioning the data transmissions and the ACK signals, the AP may receive an ACK signal which indicates that, e.g., three data subunits were properly decoded, but one was not. Thus, the AP may retransmit only the data subunit which was not properly decoded and need not retransmit the data subunits which were properly decoded.

The block ACK signals 331, 333 further include the identifier 340 such that the STAs in the sequential ACK sequence know that a received ACK signal is from a device in the network and in the current sequential ACK sequence. Accordingly, although the AP receives an ACK signal (from STAβ) at the time allocated for receipt of the ACK signal from STA2, the AP, nevertheless, may retransmit the data to STA2 during a later frame.

In another embodiment, the ACK signal may carry an identifier of the next STA in the sequence. The identifier can be a partial MAC address of the next STA in the sequence, or the sequence number of the next STA in the sequence. Including an identifier of the next STA in the sequence allows that the next STA in the sequence receives only the prior ACK signal in the sequence, which reduces the burden of having to receive all preceding ACK signals in the sequence.

In another embodiment, the ACK signal may carry an identifier of the current STA in the sequence, which can be used by the next STA in the sequence to determine that its turn to send an ACK signal has come. The identifier can be a partial MAC address of the current STA in the sequence, or the sequence number of the current STA in the sequence. Including an identifier of the current STA in the sequence allows that the next STA in the sequence receives only the prior ACK signal in the sequence, which reduces the burden of having to receive all preceding ACK signals in the sequence.

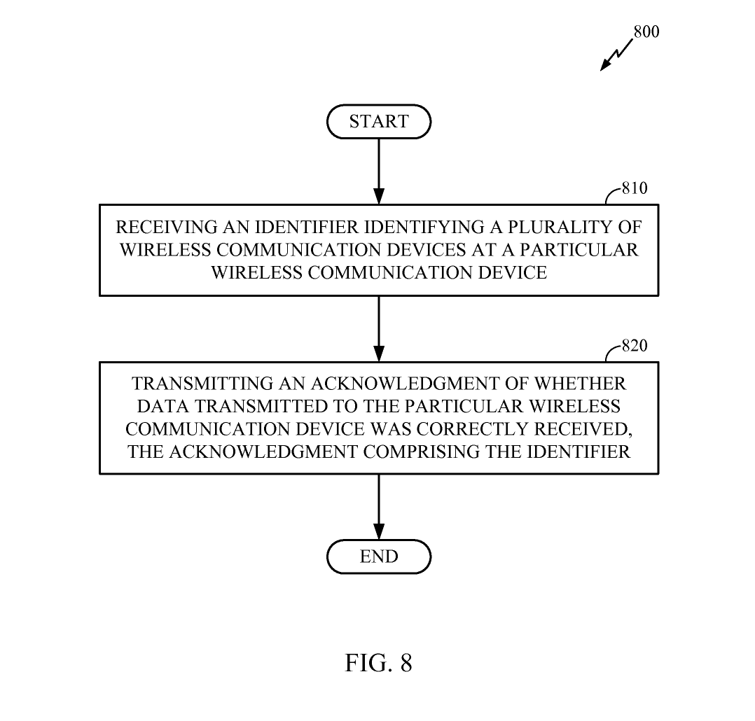

FIG. 8 illustrates an aspect of a method for transmitting an acknowledgment of data in a wireless network. The method 800 begins in block 810 with the reception, at a particular wireless communication device, of an identifier identifying a plurality of wireless communication devices information identifying a plurality of wireless communication devices. The identifier may be received by a wireless communication device via at least one of an antenna, a network interface, a modem, or a receiver. The identifier may be received as part of a PHY header. The identifier may be transmitted by an AP and received by a station associated with the AP. The identifier may identify a subset of the stations associated with the AP. The information identifying a plurality of wireless communication devices may include a group identifier (Group ID). The identifier may include a network identifier or a device identifier, such as a MAC address.

The method 800 continues to block 820 with the transmission of an acknowledgment of whether data transmitted to the particular wireless communication device was correctly received. The acknowledgment may include the identifier. The transmission may be performed, for example, by the particular wireless communication device via at least one of an antenna, a network interface, a modem, or a transmitter.

The transmission may be preceded by generation of the acknowledgment. The generation of the acknowledgment may be performed by a processor. To generate the acknowledgment, the device may receive data via a receiver and determine whether the data was properly received by decoding the data using a processor or a decoder. In another embodiment, to generate the acknowledgment, the device may determine that it has not received data.

The acknowledgment may include an ACK signal. The acknowledgment may be either a positive acknowledgment indicating that the data was correctly received or a negative acknowledgment indicating that the data was not correctly received. The acknowledgment may be a block ACK signal. The acknowledgment may include a plurality of acknowledgment subunits, each indicating whether a respective data subunit was correctly received.

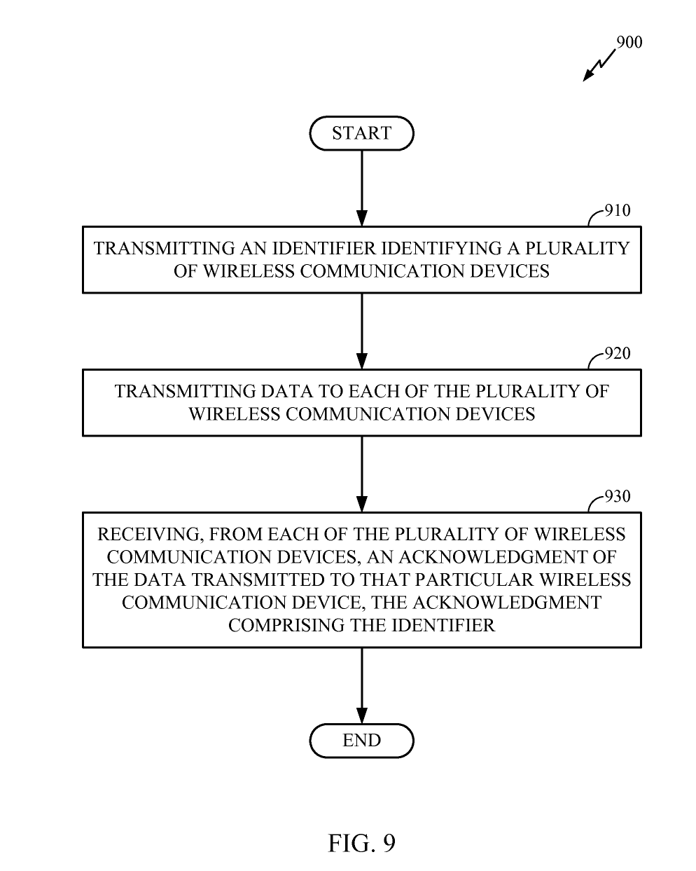

FIG. 9 illustrates an aspect of a method for receiving acknowledgments from multiple wireless devices in a wireless network. The method 900 begins in block 910 with the transmission of an identifier identifying a plurality of wireless communication devices. The identifier may be transmitted by a wireless communication device via at least one of an antenna, a network interface, a modem, or a transmitter. The identifier may be transmitted as part of a PHY header. The identifier may be broadcast to the multiple wireless devices. The identifier may be transmitted by an AP. The identifier may identify a subset of the stations associated with the AP. The identifier identifying a plurality of wireless communication devices may include a group identifier (Group ID).

The method 900 continues to block 920 with the transmission of data to each of the plurality of wireless communication devices. In one embodiment, at least a portion of the data transmitted to a first wireless communication device of the subset is transmitted concurrently with at least a portion of the data transmitted to a second wireless communication device of the subset. The data may be transmitted a wireless communication device via at least one of an antenna, a network interface, a modem, or a transmitter. The data transmitted to any particular wireless communication device may be beamformed or otherwise spatially directed to that particular wireless communication device.

The method 900 continues to block 930 with the reception, from each of the subset of the plurality of wireless communication devices, an acknowledgment of the data transmitted to that particular wireless communication device. The acknowledgment may include the identifier. The acknowledgment may be received by a wireless communication device via at least one of an antenna, a network interface, a modem, or a receiver. The acknowledgments may include an ACK signal. The acknowledgments may be includes either a positive acknowledgment indicating that the data was correctly received or a negative acknowledgment indicating that the data was not correctly received. The acknowledgments may include a block ACK signal. The acknowledgments may include an acknowledgment including a plurality of acknowledgment subunits, each indicating whether a respective data subunit was correctly received.

The acknowledgements from each of the plurality of wireless communication devices may be received sequentially without temporal gaps or with minimal temporal gaps between the acknowledgments. The method 900 may further include selectively retransmitting data to the subset of the wireless communication devices based on the received acknowledgments. In particular, the method 900 may include retransmitting data to stations which indicate (in their acknowledgments) that a data transmission or portions of a data transmission were not properly received. The method 900 may include retransmitting data to stations from which an acknowledgment is not received at a particular time. In particular, the method 900 may include retransmitting data to stations from which an acknowledgement including the identifier is not received at an allocated time.

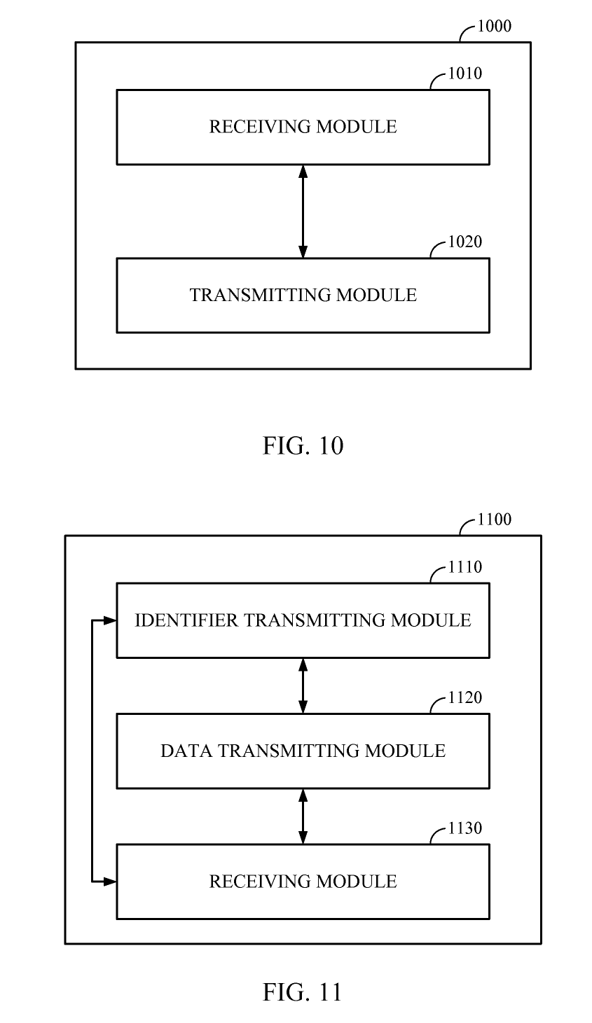

FIG. 10 is a functional block diagram of another exemplary wireless device that may be employed within the wireless communication system 100. The device 1000 comprises a receiving module 1010 for receiving an identifier identifying a plurality of wireless communication devices. The receiving module 1010 may be configured to perform one or more of the functions discussed above with respect to block 810 illustrated in FIG. 8. The receiving module 1010 may correspond to the receiver 212. The device 1000 further comprises a transmitting module 1020 for transmitting an acknowledgment. The acknowledgment may include the identifier. The transmitting module 1020 may be configured to perform one or more of the functions discussed above with respect to block 820 illustrated in FIG. 8. The transmitting module 1030 may correspond to the transmitter 210.

FIG. 11 is a functional block diagram of another exemplary wireless device that may be employed within the wireless communication system 100. The device 1100 comprises an identifier transmitting module 1110 for transmitting an identifier identifying a plurality of wireless communication devices. The transmitting module 1110 may be configured to perform one or more of the functions discussed above with respect to block 910 illustrated in FIG. 9. The transmitting module 1110 may correspond to the transmitter 210. The device 1100 further comprises a data transmitting module 1120 for transmitting data. The transmitting module 1120 may be configured to perform one or more of the functions discussed above with respect to block 920 illustrated in FIG. 9. The transmitting module 1120 may correspond to the transmitter 210. The device 1100 further comprises a receiving module 1130 for acknowledgments. One of more of the acknowledgements may include the identifier. The receiving module 1130 may be configured to perform one or more of the functions discussed above with respect to block 930 illustrated in FIG. 9. The receiving module 1130 may correspond to the receiver 212.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like. Further, a “channel width” as used herein may encompass or may also be referred to as a bandwidth in certain aspects.

As used herein, a phrase referring to “at least one of” a list of items refers to any combination of those items, including single members. As an example, “at least one of: a, b, or c” is intended to cover: a, b, c, a-b, a-c, b-c, and a-b-c.

The various operations of methods described above may be performed by any suitable means capable of performing the operations, such as various hardware and/or software component(s), circuits, and/or module(s). Generally, any operations illustrated in the Figures may be performed by corresponding functional means capable of performing the operations.

The various illustrative logical blocks, modules and circuits described in connection with the present disclosure may be implemented or performed with a general purpose processor, a digital signal processor (DSP), an application specific integrated circuit (ASIC), a field programmable gate array signal (FPGA) or other programmable logic device (PLD), discrete gate or transistor logic, discrete hardware components or any combination thereof designed to perform the functions described herein. A general purpose processor may be a microprocessor, but in the alternative, the processor may be any commercially available processor, controller, microcontroller or state machine. A processor may also be implemented as a combination of computing devices, e.g., a combination of a DSP and a microprocessor, a plurality of microprocessors, one or more microprocessors in conjunction with a DSP core, or any other such configuration.

In one or more aspects, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. Disk and disc, as used herein, includes compact disc (CD), laser disc, optical disc, digital versatile disc (DVD), floppy disk and blu-ray disc where disks usually reproduce data magnetically, while discs reproduce data optically with lasers. Thus, in some aspects computer readable medium may comprise non-transitory computer readable medium (e.g., tangible media). In addition, in some aspects computer readable medium may comprise transitory computer readable medium (e.g., a signal). Combinations of the above should also be included within the scope of computer-readable media.

The methods disclosed herein comprise one or more steps or actions for achieving the described method. The method steps and/or actions may be interchanged with one another without departing from the scope of the claims. In other words, unless a specific order of steps or actions is specified, the order and/or use of specific steps and/or actions may be modified without departing from the scope of the claims.

The functions described may be implemented in hardware, software, firmware or any combination thereof. If implemented in software, the functions may be stored as one or more instructions on a computer-readable medium. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, include compact disc (CD), laser disc, optical disc, digital versatile disc (DVD), floppy disk, and Blu-ray® disc where disks usually reproduce data magnetically, while discs reproduce data optically with lasers.

Thus, certain aspects may comprise a computer program product for performing the operations presented herein. For example, such a computer program product may comprise a computer readable medium having instructions stored (and/or encoded) thereon, the instructions being executable by one or more processors to perform the operations described herein. For certain aspects, the computer program product may include packaging material.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes and variations may be made in the arrangement, operation and details of the methods and apparatus described above without departing from the scope of the claims.

While the foregoing is directed to aspects of the present disclosure, other and further aspects of the disclosure may be devised without departing from the basic scope thereof, and the scope thereof is determined by the claims that follow.

What is claimed is:

1. A method of acknowledging received data, the method comprising:
receiving, at a wireless communication device, an identifier identifying a plurality of wireless communication devices; and
transmitting an acknowledgment of whether data transmitted to the wireless communication device was correctly received, the acknowledgment comprising the identifier.

2. The method of claim 1, wherein receiving information identifying the plurality of wireless communication devices comprises receiving a group identifier.

3. The method of claim 1, wherein the information identifying the plurality of wireless communication devices comprises information identifying a subset of wireless communication devices associated with the wireless communication device.

4. The method of claim 1, wherein transmitting the acknowledgment comprises transmitting a block acknowledgment.

5. The method of claim 1, wherein transmitting the acknowledgment comprises transmitting an acknowledgment comprising a plurality of acknowledgment subunits.

6. The method of claim 1, further comprising receiving data transmitted to the wireless communication device.

7. A method of receiving acknowledgment of transmitted data, the method comprising:
transmitting an identifier identifying a plurality of wireless communication devices;
transmitting data to each of the plurality of wireless communication devices; and
receiving, from each of the plurality of wireless communication devices, an acknowledgment of the data transmitted to that wireless communication device, the acknowledgment comprising the identifier.

8. The method of claim 7, wherein the identifier identifying the plurality of wireless communication devices comprises a group identifier.

9. The method of claim 7, wherein the identifier identifying the plurality of wireless communication devices comprises an identifier identifying a subset of wireless communication devices associated with a particular wireless communication device.

10. The method of claim 7, wherein transmitting data to each of the plurality of wireless communication devices comprises simultaneously transmitting data to each of the plurality of wireless communication devices.

11. The method of claim 7, wherein receiving, from each of the plurality of wireless communication devices, an acknowledgment comprises receiving, for at least one of the plurality of wireless communication devices, a block acknowledgment.

12. The method of claim 7, wherein receiving, from each of the plurality of wireless communication devices, an acknowledgment comprises receiving, for at least one of the plurality of wireless communication devices, an acknowledgment comprising a plurality of acknowledgment subunits.

13. The method of claim 7, wherein at least one of the received acknowledgments indicates whether at least a portion of the data transmitted to that wireless communication device was correctly received.

14. The method of claim 7, further comprising selectively retransmitting data to the plurality of wireless communication devices based on the received acknowledgments.

15. An apparatus for acknowledging received data, the apparatus comprising:
a receiver configured to receive, at a wireless communication device, an identifier identifying a plurality of wireless communication devices; and
a transmitter configured to transmit an acknowledgment of whether data transmitted to the wireless communication device was correctly received, the acknowledgment comprising the identifier.

16. The apparatus of claim 15, wherein the information identifying the plurality of wireless communication devices comprises a group identifier.

17. The apparatus of claim 15, wherein the information identifying the plurality of wireless communication devices comprises information identifying a subset of wireless communication devices associated with the wireless communication device.

18. The apparatus of claim 15, wherein the acknowledgment comprises a block acknowledgment.

19. The apparatus of claim 15, wherein the acknowledgment comprises a plurality of acknowledgment subunits.

20. The apparatus of claim 15, wherein the receiver receives data transmitted to the wireless communication device.

21. An apparatus for receiving acknowledgment of transmitted data, the apparatus comprising:
a transmitter configured to transmit an identifier identifying a plurality of wireless communication devices and to transmit data to each of the plurality of wireless communication devices; and
a receiver configured to receive, from each of the plurality of wireless communication devices, an acknowledgment of the data transmitted to that wireless communication device, the acknowledgment comprising the identifier.

22. The apparatus of claim 21, wherein the identifier identifying the plurality of wireless communication devices comprises a group identifier.

23. The apparatus of claim 21, wherein the identifier identifying the plurality of wireless communication devices comprises an identifier identifying a subset of wireless communication devices associated with a particular wireless communication device.

24. The apparatus of claim 21, wherein the transmitter is configured to simultaneously transmitting data to each of the plurality of wireless communication devices.

25. The apparatus of claim 21, wherein at least one of the received acknowledgments comprises a block acknowledgment.

26. The apparatus of claim 21, wherein at least one of the received acknowledgments comprises a plurality of acknowledgment subunits.

27. The apparatus of claim 21, wherein at least one of the received acknowledgments indicates whether at least a portion of the data transmitted to that wireless communication device was correctly received.

28. The apparatus of claim 21, wherein the transmitter is further configured to selectively retransmit data to the plurality of wireless communication devices based on the received acknowledgments.

29. An apparatus for acknowledging received data, the apparatus comprising:
means for receiving, at a wireless communication device, an identifier identifying a plurality of wireless communication devices; and
means for transmitting an acknowledgment of whether data transmitted to the wireless communication device was correctly received, the acknowledgment comprising the identifier.

30. The apparatus of claim 29, wherein the means for receiving information identifying the plurality of wireless communication devices comprises means for receiving a group identifier.

31. The apparatus of claim 29, wherein the information identifying the plurality of wireless communication devices comprises information identifying a subset of wireless communication devices associated with the wireless communication device.

32. The apparatus of claim 29, wherein the means for transmitting the acknowledgment comprises means for transmitting a block acknowledgment.

33. The apparatus of claim 29, wherein the means for transmitting the acknowledgment comprises means for transmitting an acknowledgment comprising a plurality of acknowledgment subunits.

34. The apparatus of claim 29, further comprising means for receiving data transmitted to the wireless communication device.

35. An apparatus for receiving acknowledgment of transmitted data, the apparatus comprising:
means for transmitting an identifier identifying a plurality of wireless communication devices;
means for transmitting data to each of the plurality of wireless communication devices; and
means for receiving, from each of the plurality of wireless communication devices, an acknowledgment of the data transmitted to that wireless communication device, the acknowledgment comprising the identifier.

36. The apparatus of claim 35, wherein the identifier identifying the plurality of wireless communication devices comprises a group identifier.

37. The apparatus of claim 35, wherein the identifier identifying the plurality of wireless communication devices comprises an identifier identifying a subset of wireless communication devices associated with a particular wireless communication device.

38. The apparatus of claim 35, wherein the means for transmitting data to each of the plurality of wireless communication devices comprises means for simultaneously transmitting data to each of the plurality of wireless communication devices.

39. The apparatus of claim 35, wherein the means for receiving, from each of the plurality of wireless communication devices, an acknowledgment comprises means for receiving, for at least one of the plurality of wireless communication devices, a block acknowledgment.

40. The apparatus of claim 35, wherein the means for receiving, from each of the plurality of wireless communication devices, an acknowledgment comprises means for receiving, for at least one of the plurality of wireless communication devices, an acknowledgment comprising a plurality of acknowledgment subunits.

41. The apparatus of claim 35, wherein at least one of the received acknowledgments indicates whether at least a portion of the data transmitted to that wireless communication device was correctly received.

42. The apparatus of claim 35, further comprising means for selectively retransmitting data to the plurality of wireless communication devices based on the received acknowledgments.

43. A computer readable medium comprising instructions that when executed cause an apparatus to:
receive, at a wireless communication device, an identifier identifying a plurality of wireless communication devices; and
transmit an acknowledgment of whether data transmitted to the wireless communication device was correctly received, the acknowledgment comprising the identifier.

44. The computer readable medium of claim 43, wherein the information identifying the plurality of wireless communication devices comprises a group identifier.

45. The computer readable medium of claim 43, wherein the information identifying the plurality of wireless communication devices comprises information identifying a subset of wireless communication devices associated with the wireless communication device.

46. The computer readable medium of claim 43, wherein the acknowledgment comprises a block acknowledgment.

47. The computer readable medium of claim 43, wherein the acknowledgment comprises a plurality of acknowledgment subunits.

48. The computer readable medium of claim 43, further comprising instructions that when executed cause an apparatus to receive data transmitted to the wireless communication device.

49. A computer readable medium comprising instructions that when executed cause an apparatus to:
transmit an identifier identifying a plurality of wireless communication devices;
transmit data to each of the plurality of wireless communication devices; and
receive, from each of the plurality of wireless communication devices, an acknowledgment of the data transmitted to that wireless communication device, the acknowledgment comprising the identifier.

50. The computer readable medium of claim 49, wherein the identifier identifying the plurality of wireless communication devices comprises a group identifier.

51. The computer readable medium of claim 49, wherein the identifier identifying the plurality of wireless communication devices comprises an identifier identifying a subset of wireless communication devices associated with a particular wireless communication device.

52. The computer readable medium of claim 49, comprising instructions that when executed cause an apparatus to simultaneously transmit data to each of the plurality of wireless communication devices.

53. The computer readable medium of claim 49, wherein at least one of the received acknowledgments comprises a block acknowledgment.

54. The computer readable medium of claim 49, wherein at least one of the received acknowledgments comprises a plurality of acknowledgment subunits.

55. The computer readable medium of claim 49, wherein at least one of the received acknowledgments indicates whether at least a portion of the data transmitted to that wireless communication device was correctly received.

56. The computer readable medium of claim 49, further comprising instructions that when executed cause an apparatus to selectively retransmit data to the plurality of wireless communication devices based on the received acknowledgments.
